(19) United States
(12) Patent Application Publication
(10) Pub. No.: US 2011/0230323 A1
(43) Pub. Date: Sep. 22, 2011

(54) ASSEMBLY FOR FORMING A BAG WITH A PINCH-BOTTOM SEAL

(76) Inventors: James Alan Robinette, Bristol, TN (US); James W. Abel, Collierville, TN (US)

(21) Appl. No.: 13/011,620

(22) Filed: Jan. 21, 2011

Related U.S. Application Data
(63) Continuation-in-part of application No. 12/817,079, filed on Jun. 16, 2010.
Application No. 12/817,079 is a continuation of application No. 11/441,517, filed on May 26, 2006.

(30) Foreign Application Priority Data
May 23, 2007 (US) PCT/US2007/069560

(51) Int. Cl. B31B 1/26

(52) U.S. Cl. 493/243

(57) ABSTRACT

An assembly for forming a pinch bottom bag from a tube of material including a slitter for forming slits in the tube to define a forward ply and a rear ply, a first fold track for folding the rear ply to define a folded rear ply and a second fold track for folding the front ply and the folded rear ply so the front ply contacts the rear ply to define a pinch bottom seal.

### CROSS-REFERENCE TO RELATED APPLICATIONS

The present patent application claims priority from and is: a continuation-in-part application of U.S. Ser. No. 11/441,517, filed Mar. 26, 2006, entitled Method for Closing and Sealing a Woven Polymeric Bag, which is hereby incorporated herein by reference; and a continuation-in-part application of U.S. Ser. No. 12/817,079, filed Jun. 16, 2010, entitled Improved Woven Polymeric Bag with Pinch-Bottom Seal and Method of Making the Same, which hereby is incorporated herein by reference; and claims priority from International Patent Application No. PCT/US07/69560, filed May 23, 2007, entitled Method for Closing and Sealing a Woven Polymeric Bag, which is hereby incorporated by reference.

### BACKGROUND

This disclosure pertains to a device or assembly for forming a bag with a pinch bottom seal for the containment and storage of animal feed, pet food and other similar types of contents.

Manufacturers of plastic bags have known for some time to use adhesives to seal the bottom portion of the bag. In particular, the bottom portions of paper bags have been sealed using hot melt adhesive. As is noted in U.S. patent application Ser. No. 11/441,517, filed May 26, 2006, which is one parent of the present application, hot melt adhesives may be used to seal pinch bottom bags. However, for certain applications in which the bottom seal of the bag is severely tested by heavy weight loads, the hot melt seals sometimes fail. Similarly, use of hot melt adhesives for sealing reclosable fastener profiles to bags can be found in U.S. Pat. No. 4,341,575. Moreover, examples of pinch bottom bags, apparatuses, and methods of manufacturing pinch bottom bags are seen in U.S. Pat. Nos. 6,623,162; 6,599,016; 6,367,976; 6,328,471; 5,791,485; 5,553,943; 5,474,383; 5,021,209; 4,610,651; 4,567,987; 4,550,442; 4,515,273; and 4,344,558.

### BRIEF DESCRIPTION OF THE DRAWINGS

Embodiments are disclosed herein with reference to the accompanying drawings. In the drawings, like reference numbers indicate identical or functionally similar elements.

FIG. 1 is a flow diagram of a method for sealing a bag;

FIG. 2 is a perspective view of the rear of a bag;

FIG. 3 is a perspective view of the front of a bag;

FIG. 4 is an elevational view of one lateral side of the bag showing a slit in one crease;

FIG. 5 is an elevational view of the lateral side of the bag showing the portions to be folded grouped together;

FIG. 6 is a sectional view of the lateral side of the bag after a first rearward fold;

FIG. 7 is a sectional view of the lateral side of the bag after a second rearward fold;

FIG. 8 is an elevational view of the rear side of the bag after the first rearward fold showing the treated surface of the bag and application of adhesive;

FIG. 9 is a plan view of a sealed rear wall of the bag showing a second rearward fold of one embodiment of the disclosure;

FIG. 10 is a schematic view of a portion of an assembly for forming a pinch bottom bag from a tube of material;

FIG. 11 is a schematic view of a slitting portion of the assembly of FIG. 10;

FIG. 11A is a detailed view of a portion of the slitting portion of FIG. 11;

FIG. 12 is schematic view of a first fold portion of the assembly of FIG. 10;

FIG. 12A is a detailed view of a portion of the first fold portion of FIG. 12;

FIG. 13 is a schematic view of a second fold portion of the assembly of FIG. 10; and

FIG. 13A is a detailed view of a portion of the second fold portion of FIG. 13.

### DETAILED DESCRIPTION OF THE PREFERRED EMBODIMENT

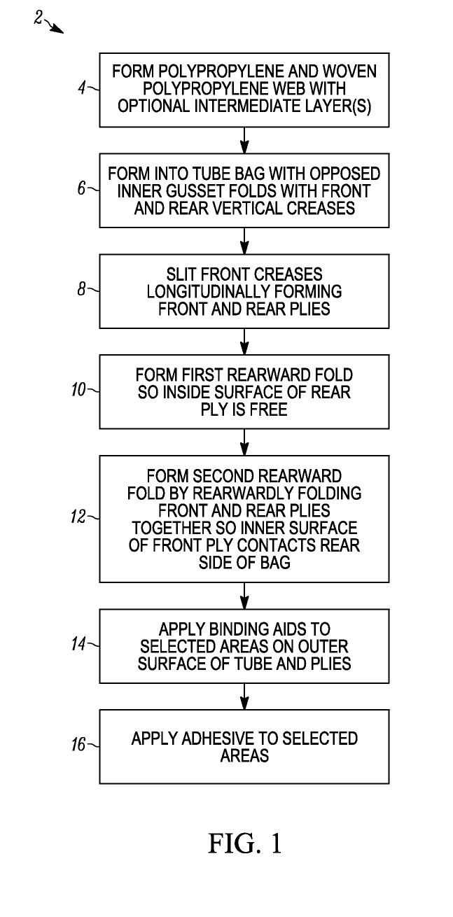

The various embodiments of the present disclosure and their advantages are best understood by referring to FIGS. 1 through 13A of the drawings. The elements of the drawings are not necessarily to scale, emphasis instead being placed upon clearly illustrating the principles of the disclosure. Throughout the drawings, like numerals are used for like and corresponding parts of the various drawings.

The drawings represent and illustrate examples of the various embodiments of the disclosure, and not a limitation thereof. It will be apparent to those skilled in the art that various modifications and variations can be made in the present disclosures without departing from the scope and spirit of the disclosure as described herein. For instance, features illustrated or described as part of one embodiment can be included in another embodiment to yield a still further embodiment. Moreover, variations in selection of materials and/or characteristics may be practiced to satisfy particular desired user criteria. Thus, it is intended that the present disclosure covers such modifications as come within the scope of the features and their equivalents.

Furthermore, any reference in the specification to “an embodiment,” “one embodiment,” “various embodiments,” or any variant thereof means that a particular feature or aspect of the disclosure described in conjunction with the particular embodiment is included in at least one embodiment of the present disclosure. Thus, the appearance of the phrases “in one embodiment,” “in another embodiment,” or variations thereof in various places throughout the specification are not necessarily all referring to its respective embodiment.

In one aspect of the present disclosure, an assembly for forming a pinch bottom bag from a tube of material may include a vacuum bar for holding the tube, a slitter for forming slits in the tube to define a forward ply and a rear ply, a first fold track for folding the rear ply to define a folded rear ply and a second fold track for folding the front ply and the folded rear ply so the front ply contacts the rear ply to define a pinch bottom seal.

In another aspect of the present disclosure, the assembly for forming a pinch bottom bag from a tube of material that has a front side, a rear side and a pair of opposing inward-tending gusset folds disposed between the front and rear side may include a slitting portion, a first fold portion and a second fold portion. The slitting portion may include a vacuum bar for holding the front side of the tube stationary, a blower tube for opening the tube by lifting the rear side and a slitter for forming a slit in each of the pair of gusset folds adjacent an outer crease and the front side to define a forward ply and a rear ply. The first fold portion may include a first fold track having a bottom rail and a top rail and extending from a first end to a second end, such that when the tube is moved from the slitting portion the rear ply is disposed within the first fold track between the top and bottom rails and the forward ply is disposed below the bottom rail so that when the tube is moved from the first end to the second end the rear ply is folded along a first rearward fold defined between a vertex of each of the slits to define a folded rear ply. The second fold portion may include a second fold track including a bottom track and a top track and extending from a first end to a second end, such that when the tube is moved from the first fold portion the front ply and the folded rear ply are disposed within the second fold track between the top and bottom rails so that when the tube is moved from the first end to the second end of the second fold track the front ply and the folded rear ply are folded along a second rearward fold defined adjacent an extent of the folded rear ply such that the front ply contacts the rear ply to define a pinch bottom seal.

In yet another aspect of the present disclosure, the assembly may further include a blower tube for opening the tube to facilitate forming the slits, a press roller for creasing the pinch bottom seal and securing the front ply to the rear ply, a sensor for activating the slitter, a single air source connected to the vacuum bar and the blower tube and/or a limit bar to control an extent that the blower tube opens the tube.

In still yet another aspect of the present disclosure, the slitter may be rotatable responsive to an optical sensor in a counter-clockwise direction to form one slit and in a clockwise direction to form another slit adjacent.

In a further aspect of the present disclosure, the first fold track may include a twist of approximately 180° from a first end to a second end, the first end of the first fold track overlaps the vacuum bar and/or a first end of the second fold track overlaps the second end of the first fold track such that the second end of the first fold track is disposed within the first end of the second fold track.

In a still further aspect of the present disclosure, the second fold track may include a twist of approximately 180° from a first end to a second end and/or a glue dispenser disposed before the twist of the second fold track.

In yet another aspect of the present disclosure, the single air source may be a regenerative blower.

Preferred embodiments of the disclosure include a device or assembly for forming a pinch bottom bag from a tube of material. The pinch-bottom closure provides strength and durability to the bag so that polymer film can be used for making the bag. The bag preferably contains a polymer outer layer, for example, biaxially-oriented polypropylene or polypropylene and a woven polymer layer, for example, woven polypropylene adjacent the outer layer to provide strength to the bag. Further, the bag may contain an extruded layer and other layers for convenience. However, the polymer layer and woven polymer layer in combination with the pinch bottom produces a preferred bag. Notwithstanding the foregoing, the assembly may be used in connection with any suitable material to form the preferred pinch bottom bag. Preferably, the assembly may include a vacuum bar, a slitter a first fold track and a second fold track.

FIG. 1 describes the process flow 2 for generally preparing a pinch bottom bag including a pinch bottom seal. In reference 4, a sheet of polypropylene and woven polypropylene, or other suitable material, may be blended together to form a tube or tube-like structure by any suitable conventional method. An intermediate layer may be added by extrusion or other conventional means. The extruded intermediate layer may be one or more layers of polyethylene, paper, or other polymer. The intermediate layer supplies support for the film and contacts the contents of the bag. One intermediate layer may absorb oil, moisture, or any other material or the contents may include bulk items such as food, kitty litter, farm animal feed, etc. The sheet for web is then formed into a tube by conventional means at reference 6. Sheets may also be utilized. While moving on a conveyor, the tube may be subjected to a binding aid, such as, for example, plasma treatment or corona treatment for preparing the surface of the polymer film for receiving an adhesive in one or more areas, primarily the bottom of the bag and the top of the bag in areas that will receive a hot melt adhesive. In reference 6, the tube is cut to size then folded to form a bag with gussets with front and rear vertical creases. A slit may be made in an outer crease adjacent to the side of the bag that will be in the front of the bag in reference 8. The slit creates the front ply and a first rearward fold is creased so that the inside surface of the rear ply is free as shown in reference 10. In reference 12, a second rearward fold is formed by rearwardly folding front and rear plies together so inner surface of the front ply contacts the rear side of the bag. In reference 14, a binding aid may be applied in the second rearward fold is folded rearwardly so that the rear plies come together. In this manner, the inner surface of front ply contacts the rear side of the bag in the area that has been pretreated by a binding aid and the second rearward fold is made. In reference 16, hot melt adhesive or conventional adhesive is applied to the area that has been pretreated by the plasma treatment. The bag is sealed by folding the rearward ply onto the area containing the adhesive.

The top of the bag may be closed by conventional means, for example, by folding the top edge of the bag and applying an adhesive to the folded portion facing the wall of the bag and the area of the wall of the bag contacting the fold. Adhesive with a pull string, may also be used to seal top opening of the bag. The bottom seal, however, is preferably closed by a pinch seal. Alternative seals for the top of the bag also include the use of reclosable seal with or without a slider placed on the inside wall of the bag below conventional sealing means at the very top of the bag. The reclosable seal inside the walls of the bag provide additional protection for freshness of contents, which typically may be animal food or other edible food product.

A pinch seal may also be used for sealing the top of the bag. The binding aids, preferably plasma treatment and corona treatment, are used with the adhesive, preferably a hot melt adhesive for sealing the top of the bag. Ultrasonic sealing may also be used to seal the top of the bag with a pinch seal with or without adhesive.

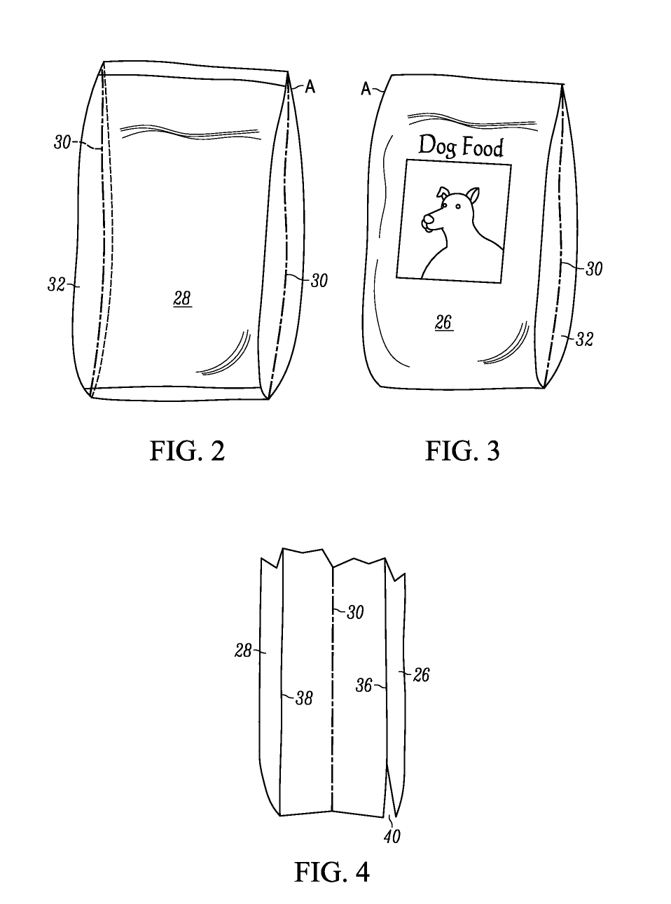

A more detailed description of the method and bag is shown in FIGS. 2 and 3 where bag A is of the type often used for animal feed, or similar types of contents. Bag A is made from a durable, flexible material suitable for such containment and storage of such material. One nonlimiting example of such a material is a polymer, particularly a polyolefin, preferably polypropylene, and further, biaxially-oriented polypropylene and/or woven polypropylene. These polymers can be blended in combination or used in separate, distinct sheets. Other examples include polyethylene and blends of polypropylene and polyethylene and separate layers of polymers, paper, and other extrusion layers can be utilized with the separate woven polypropylene layer adjacent the propylene outer layer. Bag A is formed from a tube-like structure which is cut to size. Alternatively it is formed from sheets that are confined to form a tube-like structure. Then one end is closed and sealed, the bag is filled, and the opposing end is then sealed. For orientational reference only and not in any limiting sense, bag A includes a front side 26, and an opposing rear side 28. The front side 26 may be considered the side on which prominent displays of labeling comprising, for example, graphic designs, trademarks, and the like, a notional example of which is represented in FIG. 3. For storage purposes when the bag is empty, bag A is collapsible, having a pair of opposing inwardly projecting gusset-type folds 30 formed at the lateral sides 32, 34 of the bag.

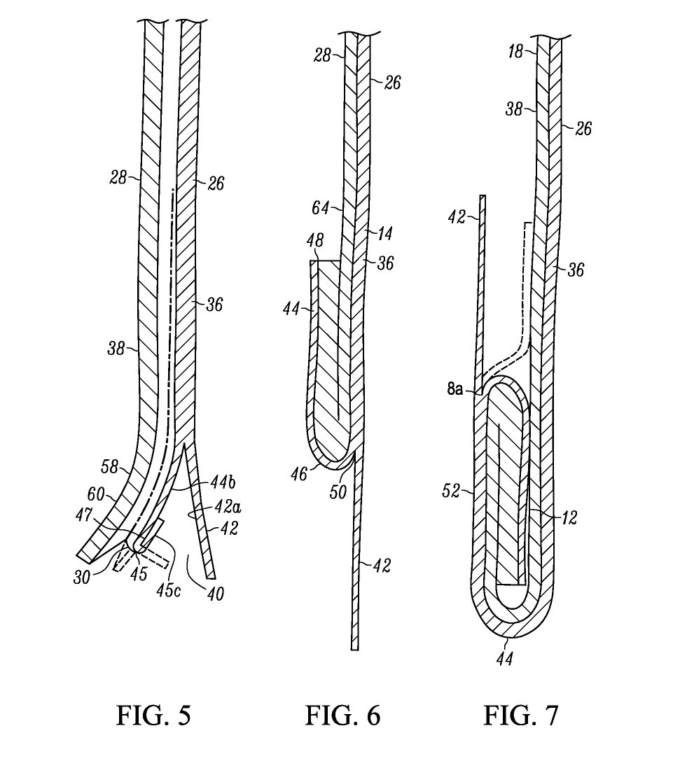

FIG. 4 illustrates an end portion of an unclosed bag A, viewed from the perspective of a gusset fold 30, where two outer creases 36, 38 forming a gusset fold 30 are referenced. FIGS. 4-7 do not show all the plies of the bag in order to facilitate the understanding of an embodiment of the disclosure. In FIG. 5, a slit 40 is made adjacent an outer crease 36, preferably the outer crease adjacent the side of bag A that will be the front 26 of the bag. The slit 40 then creates a forward ply 42 and a rear ply 44. The forward ply 42 is kept in place while a first rearward fold 46 (FIG. 6) is formed by folding the rear ply 44 along to create rear fold 48. First rearward fold 46 is creased roughly at the vertex 50 of slit 40. A second rearward fold 52 (FIG. 7) is created by folding the entire bag A rearward where it is creased approximately at or above the level reached by the ends of the plies 42 (indicated by ghosted line) after the first rearward fold.

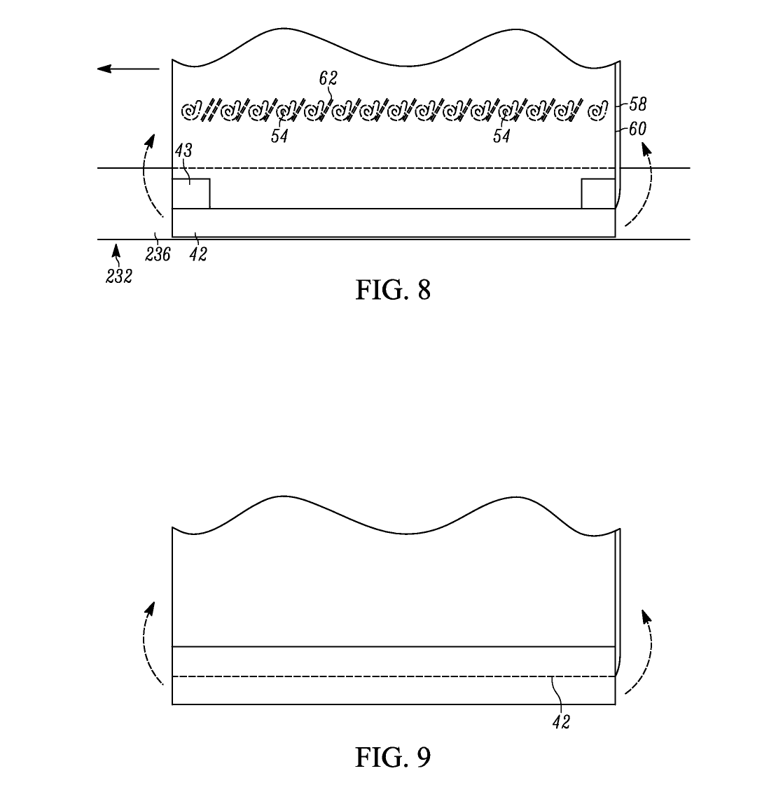

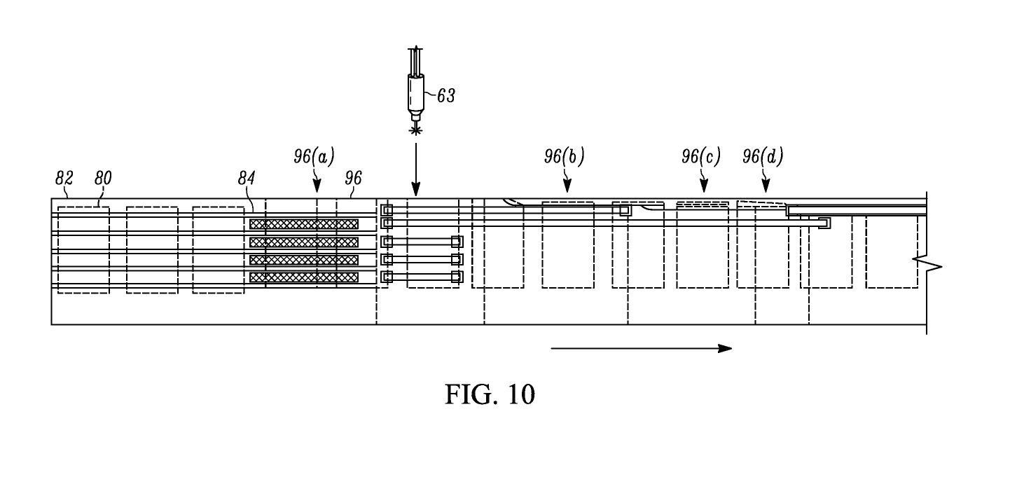

Referring to FIGS. 8 and 9, means for securing the fold is illustrated in FIG. 8 where after the first rearward fold 46, adhesive 54 is deposited on the inner surface 56 of rearward ply 44. However, before the deposition of the adhesive 54 which may or may not be a hot melt adhesive on first portion 58 of rear side wall 28 that will contact a second portion 60 of rear side wall 28 when rear ply 44 is folded, the inner surface 43 of ply 42 is preferably treated by a binding agent, for example, plasma treatment to clean the surface at an atomic level, thereby removing contaminants such as dust, moisture, etc. This treatment also increases the surface tension by activating the polymer structure and improving the wettability of the polymer. It also creates improved chemical bonding for better coating and bonding of substances applied to the polymer substrate. In addition, the treatment removes electrostatic charges. The treatment also applied to second portion 60 and first portion 58 of side wall. In the area treated, the actual surface is increased by a large degree, possibly up to 30%. In FIG. 8, the treated area is shown by slashed lines 62 with the adhesive 54 overlaying the treated area on the inner surface 56 of rearward ply 44.

Adhesive 54 may be any suitable adhesive for securing or bonding the material to itself. By way of nonlimiting example, adhesive 54 may be a hot melt adhesive known to those skilled in the relevant arts. In another embodiment, adhesive 54 is also deposited upon the rear surface 28 of the bag A within the area at which the inner surface of plies 44 and 42 contact it.

Within the adhesives industry hot melt adhesives are known to have good performance and usage benefits, as understood by those skilled in the art. Hot melt adhesives are solvent-free adhesives, that are characteristically solid at temperatures below 180° F., are low viscosity fluids above 180° F., and rapidly set upon cooling. The development of hot melt adhesive technology stemmed from the previous use of molten wax for bonding. Hot melt adhesives are used in a variety of manufacturing processes. There are a number of hot melt adhesives in use, with the most common being those used for hot melt pressure sensitive adhesive applications: ethylene vinyl acetate (EVA) copolymers, compatible with paraffin, the original hot melt; styrene-isoprene-styrene (SIS) copolymers; styrene-butadiene-styrene (SBS) copolymers; ethylene ethyl acrylate copolymers (EEA); and polyurethane reactive (PUR).

FIG. 9 depicts the completed folded closure. Inner surface 56 of rearward ply 44 (represented by dashed line) is bonded to rear surface 28 of bag A at second portion 60. Front ply 42 of front side 24 extends roughly vertically with respect to the bag, beyond the crease 64 of first rearward fold 46 and inner surface 43 is bonded to first portion 58 of rear side 28. FIG. 3 shows an exemplary bag A from the front perspective where it is apparent that an observer cannot see any seams, seals, or closures, thus presenting a more aesthetically pleasing package to the customer.

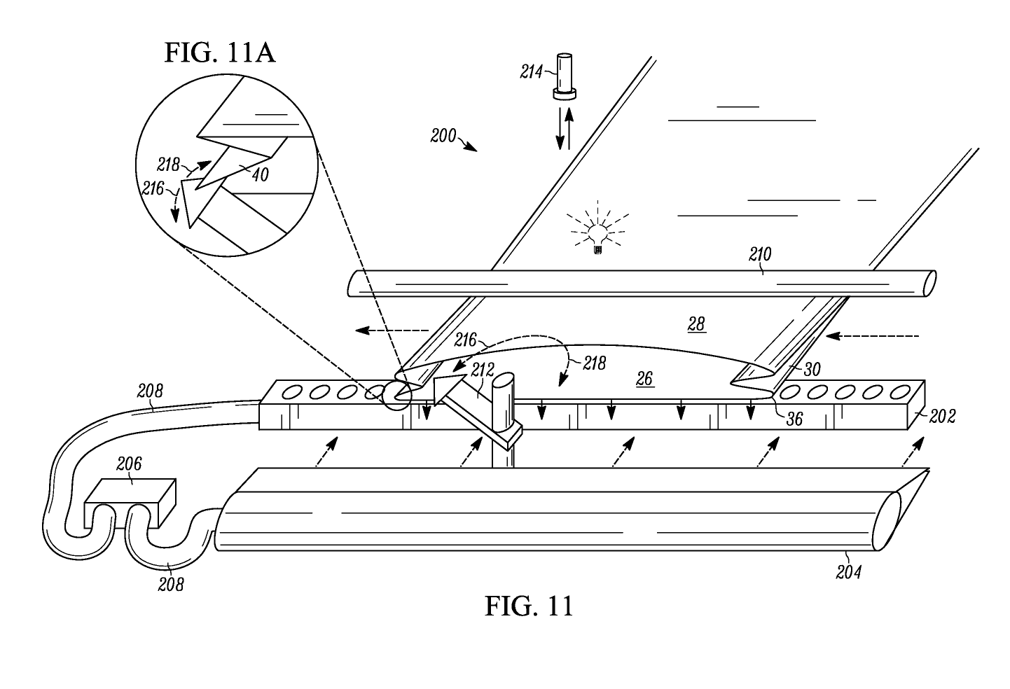

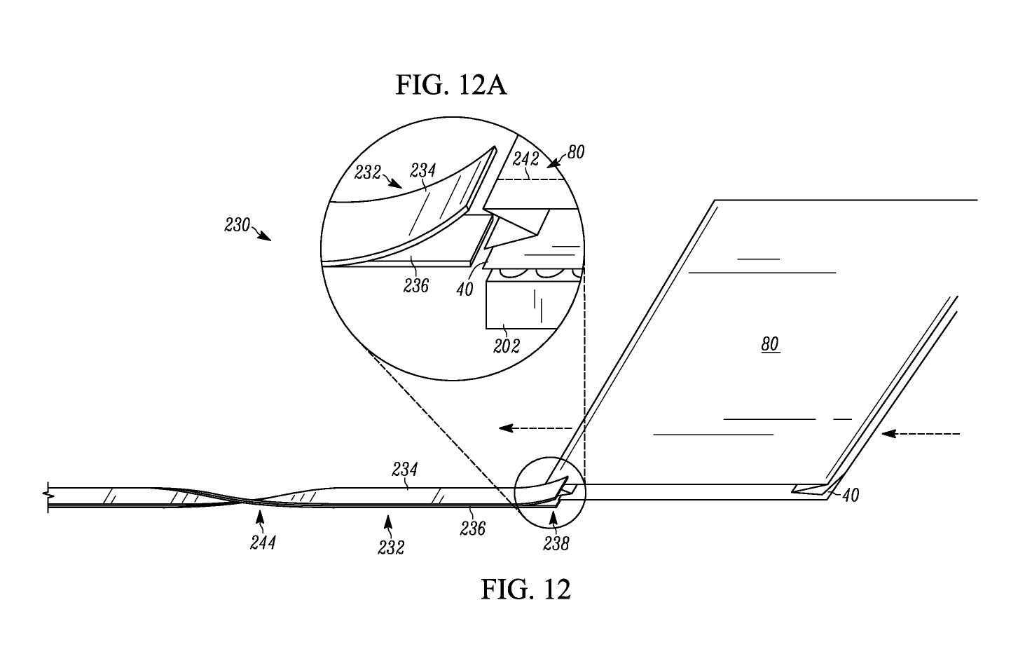

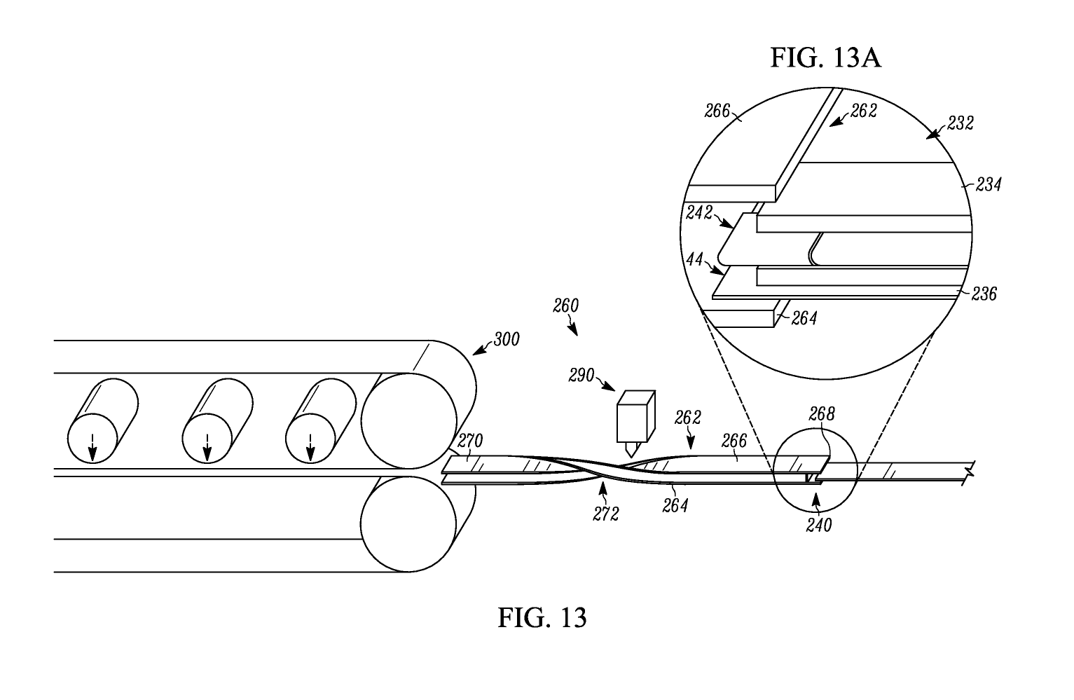

As seen in FIG. 10 of the drawings, like precut polypropylene tube-like material structures 80 are disposed on a conveyor 82 in process line and are moved through a series of roller assemblies 84. The slit front side 28 of bag A is performed in process 96 at station 96(a) as will be described below with respect to FIGS. 11 and 11A. Rear ply 44 is folded at station 96(b) to define a first rearward fold as will be described below with respect to FIGS. 12 and 12A. A binding aid, for example, plasma treatment or corona treatment 63 may be applied to second portion 60 of rear side 28 to prepare the ply 42 for improved binding with the addition of an adhesive. Corona treatment 310, when utilized, is applied here. At station 96(c), adhesive 54 is applied. If ultrasonic vibration is used as a binding aid, it is utilized here and adhesive 56 is optional. Station 96(d) manipulates front and rear plies 42, 44 rearward to define a second rearward fold as will be described below with respect to FIGS. 13 and 13A. Bag A is then filled with contents or stored in folded position by the collapsing of gussets 30 in an area of the process line not shown.

At station 96(d) the second rearward fold is then compressed against the back side 28 of the bottom of the bag so as to form a strong pinch seal. Inner surface 43 of forward ply 42 may also be subjected to pretreatment and application of an adhesive.

FIGS. 11 and 11A illustrate a detailed view of station 96(a) of process 96 as shown in FIG. 10. This process 96 represents an assembly, apparatus or device for forming a pinch bottom bag from a tube of material in accordance with the teachings of this disclosure. As described above, the bag, in one embodiment, has a front side 26, an opposing rear side 28 and a pair of opposing inward-tending gusset folds 30 disposed between the front and rear sides 26, 28. Station 96(a) of the assembly or process 96 may include a slitting portion 200 comprised of various structural and functional elements that may be arranged in any suitable order so as to provide the intended functionality that are shown in FIGS. 11 and 11A in a schematic format so that the present disclosure is understandable. However, one of ordinary skill in the art will recognize that various options for achieving the intended functionality may be available. For example, the slitting portion 200 may include a vacuum bar 202 for holding the front side 26 of the tube 80 stationary at a desired location within the slitting portion 200. The vacuum bar 202 may extend substantially along the entire length of the slitting portion 200 and in another embodiment may extend beyond the slitting portion 200 as may be advantageous. In yet another embodiment, the vacuum bar 202 may include a substantially planar top surface that has a plurality of openings formed therein that communicate with a plenum that is in communication with a pump or other source of vacuum. One of skill in the art will recognize that activation and deactivation of the pump or vacuum source may be advantageous to facilitate movement of the tube 80 longitudinally along the length of the vacuum bar 202 that is disposed normal to the tube 80.

The slitter portion 200 may also include a blower tube 204 that is configured to discharge a flow of air received from an pump or other source of compressed air for opening the tube 80 by lifting the rear side 28 and the pair of gusset folds 30. In one embodiment, the blower tube 204 may include an opening that has an extent along the length of the vacuum bar 202 that is generally similar to the tube 80. However, one of ordinary skill in the art will recognize that the extent of the opening may be considerably less than the open end of the tube 80 and still provide the intended functionality. Preferably, the blower tube 204 includes a plenum that is in communication with the pump or other source of compressed air and the opening such that the compressed air is discharged at a controlled rate, regulated by the opening, toward the open end of the tube 80 with sufficient volume to lift the rear side 28 and the gusset folds 30 thereby opening the tube 80.

In one advantageous embodiment, a single air source 206 may connected to, in communication with and supplying both the vacuum bar 202 and the blower tube 204 by a pair of hoses, tubes, pipes or other suitable conduit 208. Preferably, the single air source 206 may be a regenerative blower or any other suitable device to provide the intended functionality.

The slitter portion 200 may also include a limit bar 210 that is disposed in the slitting portion 200 above the tube 80 to control an extent that the blower tube 204 opens and lifts the tube 80. In one embodiment, the limit bar 210 is disposed adjacent the rear side 28 so as to restrict the lift of the tube 80 immediately adjacent the limit bar 210 and otherwise control and restrain movement of the tube 80 in an upward direction. One of ordinary skill in the art will recognize that any suitable structure for the limit bar 210 may be incorporated to perform the intended functionality.

In station 96(a) the slitter portion 200 may also include a slitter 212 for forming a slit 40 in each of the pair of gusset folds 30 adjacent an outer crease 36 and the front side 26 to define a forward ply 42 and a rear ply 44. In one embodiment, an optical sensor 214 or other suitable device may be used to activate the slitter 212 relative to the position of the tube 80. For example, the optical sensor 214 may include a sensor and a corresponding light source disposed in opposition such that the tube 80 blocks the light source from the sensor which effectively functions as the trigger mechanism. As one of ordinary skill in the art will recognize, other similar triggering mechanisms may be used to achieve the same functionality, such as a laser sensor, optical positioning system or the like. In another embodiment, the slitter 212 may be rotatable in a counter-clockwise direction 216 to form the slit 40 adjacent a leading outer crease 36 and in a clockwise direction 218 to form the slit 40 adjacent a trailing outer crease 36.

FIGS. 12 and 12A illustrate a detailed view of station 96(b) of process 96 as shown in FIG. 10. Station 96(b) of the assembly or process 96 may include a first fold portion 230 comprised of various structural and functional elements that may be arranged in any suitable order so as to provide the intended functionality that are shown in FIGS. 12 and 12A in a schematic format so that the present disclosure is understandable. However, one of ordinary skill in the art will recognize that various options for achieving the intended functionality may be available. For example, the first fold portion 230 may be disposed adjacent the slitting portion 200 and may include a first fold track 232 having a bottom rail 236 and a top rail 234 and extending from a first end 238 to a second end 240 (see FIGS. 13 and 13A). In one embodiment, the first end 238 of the first fold track 232 may overlap the vacuum bar 202. In another embodiment, the first fold track 232 has an enlarged opening disposed at the first end 238 and defined by a separation of the top and bottom rails 234, 236 that is greater at the first end 238 than elsewhere along the length of the first fold track 232. One of ordinary skill in the art will recognize that the enlarged opening facilitates smooth transition of the tube 80 from the slitter portion 200 to the first fold portion 230. In one embodiment, when the tube 80 is moved along the vacuum bar 202 from the slitting portion 200 the rear ply 44 is disposed within the first fold track 232 between the top and bottom rails 234, 236 and the forward ply 42 is disposed below the bottom rail 236 so that when the tube 80 is moved from the first end 238 to the second end 240 the rear ply 44 is folded along a first rearward fold 242 defined as a line extending between a vertex of each of the slits 40 to define a folded rear ply (as shown in FIGS. 6 and 8). In another embodiment, the first rearward fold 242 may be in the range of at least approximately 0.01 inches to an extent necessary relative to the expected load exerted by the contents of the bag. In other words, the extent of the first rearward fold 242 may be any suitable distance relative to the strength necessary to provide an adequate pinch bottom seal in view of the loads that the contents of the bag will likely exert on the seal. Preferably, in one embodiment, the first rearward fold 242 would be approximately five eights (⅝) of one inch. In one embodiment, the first fold track 232 may include a twist 244 disposed between the first and second ends 238, 240. Preferably, in one embodiment, the twist 244 is approximately one hundred eighty degrees) (180° that is spread over approximately five feet of first fold track 232 length so that the first rearward fold 242 when the tube 80 is disposed at the second end 240 is disposed as shown in FIG. 6.

FIGS. 13 and 13A illustrate a detailed view of stations 96(c) and 96(d) of process 96 as shown in FIG. 10. Stations 96(c) and 96(d) of the assembly or process 96 may include a second fold portion 260 comprised of various structural and functional elements that may be arranged in any suitable order so as to provide the intended functionality that are shown in FIGS. 13 and 13A in a schematic format so that the present disclosure is understandable. However, one of ordinary skill in the art will recognize that various options for achieving the intended functionality may be available. For example, the second fold portion 260 may be disposed adjacent the first fold portion 230 and preferably immediately adjacent the second end 240 of the first fold portion 230. The second fold portion 260 may include a second fold track 262 including a bottom rail 264 and a top rail 266 that extend from a first end 268 to a second end 270. In one embodiment, the first end 268 of the second fold track 262 overlaps the second end 240 of the first fold track 232 such that the second end 240 of the first fold track 232 is disposed within the top and bottom rails 264, 266 of the first end 268 of the second fold track 262. In another embodiment, the first end 268 of the second fold track 262 may include an initial opening dimension at the first end 268 that is greater than an outer dimension of the first fold track 232 at the second end 240. One of ordinary skill in the art will recognize that the initial opening dimension facilitates smooth transition of the tube 80 from the first fold portion 230 to the second fold portion 260. In one embodiment, when the tube 80 is moved from the first fold portion 230 the front ply 42 and the folded rear ply 44 (i.e., the first reward fold 242) are disposed within the second fold track 262 between the top and bottom rails 266, 264 so that when the tube 80 is moved from the first end 268 to the second end 270 of the second fold track 262 the front ply 42 and the folded rear ply 44 (i.e., the first reward fold 242) are folded along a second rearward fold 14 (see FIGS. 6, 7 and 8) defined adjacent an extent of the folded rear ply 44 (i.e., the first reward fold 242) such that the front ply 42 contacts the rear ply 44 above the first rearward fold 242 to define a pinch bottom seal (see FIGS. 7 and 9). In another embodiment, the second rearward fold 14 may be in the range of at least approximately 0.01 inches from the first rearward fold 242 to an extent necessary relative to the expected load exerted by the contents of the bag. In other words, the extent of the second rearward fold 14 may be any suitable distance relative to the strength necessary to provide an adequate pinch bottom seal in view of the loads that the contents of the bag will likely exert on the seal. Preferably, in one embodiment, the second rearward fold 14 would be approximately one and three quarters (1¾) inches from the end of the front ply 42 adjacent the second fold track 262. In one embodiment, the second fold track 262 may include a twist 272 disposed between the first and second ends 268, 270. Preferably, in one embodiment, the twist 272 is approximately one hundred eighty degrees (180°) that is spread over approximately four feet of second fold track 262 length so that the second rearward fold 14 when the tube 80 is disposed at the second end 270 is disposed as shown in FIGS. 7 and 9. In another embodiment, a glue dispenser 290 may be disposed at a location before the twist 272 of the second fold track 262. One of ordinary skill in the art will recognize that the glue dispenser 290 may be any suitable conventional device to provide the intended functionality.

In another embodiment, a press roller 300 may be disposed adjacent the second fold portion 260 for creasing the pinch bottom seal and securing the front ply 42 to the rear ply 44. One of ordinary skill in the art will recognize that the press roller 300 may be any suitable conventional device to provide the intended functionality.

While particular embodiments of the present disclosure have been described, it will be understood, however, that the present disclosure is not limited thereto, since modifications may be made by those skilled in the art, particularly in light of the foregoing teachings. It is, therefore, contemplated by the following claims to cover any such modifications that incorporate those features or those improvements that embody the spirit and scope of the present disclosure.

What is claimed is:

1. An assembly for forming a pinch bottom bag from a tube of material, the assembly comprising: a vacuum bar for holding the tube; a slitter for forming a pair of opposed slits in the tube to define a forward ply and a rear ply when the tube is held by the vacuum bar; a first fold track disposed adjacent the slitter for folding the rear ply to define a folded rear ply; and a second fold track disposed adjacent the first fold track for folding the front ply and the folded rear ply such that the front ply contacts the rear ply to define a pinch bottom seal.

2. The assembly as recited in claim 1, further comprising a blower tube for opening the tube when held by the vacuum bar to facilitate formation of the pair of opposed slits.

3. The assembly as recited in claim 1, further comprising a press roller for creasing the pinch bottom seal and securing the front ply to the rear ply.

4. The assembly as recited in claim 1, further comprising an optical sensor for activating the slitter.

5. The assembly as recited in claim 2, further comprising a single air source connected to and supplying both the vacuum bar and the blower tube.

6. The assembly as recited in claim 4, wherein the slitter is rotatable responsive to the optical sensor in a counter-clockwise direction to form the slit adjacent a leading outer crease and in a clockwise direction to form the slit adjacent a trailing outer crease.

7. The assembly as recited in claim 2, further comprising a limit bar disposed parallel to the vacuum bar and the blower tube and above the tube to control an extent that the blower tube opens the tube.

8. The assembly as recited in claim 1, wherein a first end of the first fold track overlaps the vacuum bar.

9. The assembly as recited in claim 8, further comprising a first end of the second fold track that overlaps the second end of the first fold track such that the second end of the first fold track is disposed within the first end of the second fold track.

10. The assembly as recited in claim 1, further comprising a glue dispenser disposed before a twist of the second fold track.

11. The assembly as recited in claim 5, wherein the single air source is a regenerative blower.

12. The assembly of claim 1 wherein said forward ply comprises biaxially oriented polypropylene and said rear ply comprises woven polypropylene.

13. An assembly for forming a pinch bottom bag from a tube of material having a front side, a rear side and a pair of opposing inward-tending gusset folds disposed between the front and rear side, the assembly comprising: a slitting portion including a vacuum bar for holding the front side of the tube stationary at a desired location within the slitting portion, a blower tube for opening the tube by lifting the rear side and the pair of gusset folds and a slitter for forming a slit in each of the pair of gusset folds adjacent an outer crease and the front side to define a forward ply and a rear ply; a first fold portion disposed adjacent the slitting portion, the first fold portion including a first fold track having a bottom rail and a top rail and extending from a first end to a second end, such that when the tube is moved from the slitting portion the rear ply is disposed within the first fold track between the top and bottom rails and the forward ply is disposed below the bottom rail so that when the tube is moved from the first end to the second end the rear ply is folded along a first rearward fold defined between a vertex of each of the slits to define a folded rear ply; a second fold portion disposed adjacent the first fold portion, the second fold portion including a second fold track including a bottom rail and a top rail and extending from a first end to a second end, such that when the tube is moved from the first fold portion the front ply and the folded rear ply are disposed within the second fold track between the top and bottom rails so that when the tube is moved from the first end to the second end of the second fold track the front ply and the folded rear ply are folded along a second rearward fold defined adjacent an extent of the folded rear ply such that the front ply contacts the rear ply to define a pinch bottom seal.

14. The assembly as recited in claim 13, further comprising an optical sensor for activating the slitter.

15. The assembly as recited in claim 13, further comprising a single air source connected to and supplying both the vacuum bar and the blower tube.

16. The assembly as recited in claim 13, wherein the slitter is rotatable in a counter-clockwise direction to form the slit adjacent a leading outer crease and in a clockwise direction to form the slit adjacent a trailing outer crease.

17. The assembly as recited in claim 13, further comprising a limit bar disposed in the slitting portion above the tube to control an extent that the blower tube opens and lifts the tube.

18. The assembly as recited in claim 13, wherein the first end of the first fold track overlaps the vacuum bar.

19. The assembly as recited in claim 13, wherein the first end of the second fold track overlaps the second end of the first fold track such that the second end of the first fold track is disposed within the top and bottom rails of the first end of the second fold track.

20. The assembly as recited in claim 13, further comprising a glue dispenser disposed before a twist of the second fold track.

21. The assembly as recited in claim 15, wherein the single air source is a regenerative blower.

22. The assembly as recited in claim 13, further comprising a press roller disposed adjacent the second fold portion for creasing the pinch bottom seal and securing the front ply to the rear ply.

23. The assembly as recited in claim 13 wherein said forward ply comprises biaxially oriented polypropylene and said rear ply comprises woven polypropylene.
